(19) United States
(12) Patent Application Publication
(10) Pub. No.: US 2016/0316371 A1
(43) Pub. Date: Oct. 27, 2016

(54) LOCATION-BASED ACCESS CONTROL METHODS, CLOUD SERVER, AND CLIENT TERMINAL UTILIZING THE SAME

(71) Applicant: AthenTek Inc., Taipei City (TW)

(72) Inventor: Chun-Nan Chen, Taipei City (TW)

(21) Appl. No.: 14/822,817

(22) Filed: Aug. 10, 2015

Related U.S. Application Data
(60) Provisional application No. 62/152,184, filed on Apr. 24, 2015.

(51) Int. Cl. H04W 12/08; H04W 8/00; H04W 12/06; H04L 29/06; H04L 29/08

(52) U.S. Cl. CPC H04W 12/08; H04L 67/42; H04L 67/10; H04W 12/06; H04W 8/005

(57) ABSTRACT

Location-based access control methods, a cloud server, and a client terminal utilizing the same are provided. The method is adopted by a cloud server to provide access controls, and includes: receiving an access control request and a first radio environment from a first client terminal; receiving a second radio environment from a second client terminal; and processing the access control request based on the first radio environment and the second radio environment.

### CROSS REFERENCE TO RELATED APPLICATIONS

This Application claims priority of U.S. Provisional Application No. 62/152,184, filed on Apr. 24, 2015, and the entirety of which is incorporated by reference herein.

### BACKGROUND OF THE INVENTION

1. Field of the Invention

The present invention relates to information security, and in particular to location-based access control methods, a cloud server, and a client terminal utilizing the same.

2. Description of the Related Art

Access control provides restricted access to sensitive information, preventing the sensitive information such as a credit card number or an alarm code from unauthorized access, use, disclosure, disruption, modification, inspection, recording or destruction. Therefore, location-based access control methods, a cloud server, and a client terminal utilizing the same are in need to help cover an increasing need for information security and privacy.

### BRIEF SUMMARY OF THE INVENTION

A detailed description is given in the following embodiments with reference to the accompanying drawings.

An embodiment of a method is described, adopted by a cloud server to provide access controls, comprising: receiving an access control request and a first radio environment from a first client terminal; receiving a second radio environment from a second client terminal; and processing the access control request based on the first radio environment and the second radio environment.

Another embodiment of a system is revealed, adopted by a client terminal to provide access controls, comprising: upon receiving an access control request from a cloud server, scanning radio sources in a first environment to generate a first radio environment; receiving a second radio environment from the cloud server; and processing the access control request based on the first radio environment and the second radio environment.

Another embodiment of a cloud server is disclosed, providing access controls, comprising a transceiver and a location-based authentication circuit. The transceiver is configured to receive an access control request and a first radio environment from a first client terminal, and receive a second radio environment from a second client terminal. The location-based authentication circuit, coupled to the transceiver, is configured to process the access control request based on the first radio environment and the second radio environment.

Another embodiment of a client terminal is provided, providing access controls, comprising a transceiver and a location-based authentication circuit. Upon receiving an access control request from a cloud server, the transceiver is configured to scan radio sources in a first environment to generate a first radio environment, and a second radio environment from the cloud server. The location-based authentication circuit, coupled to the transceiver, is configured to process the access control request based on the first radio environment and the second radio environment

### BRIEF DESCRIPTION OF THE DRAWINGS

The present invention can be more fully understood by reading the subsequent detailed description and examples with references made to the accompanying drawings, wherein:

FIG. 1 is a block diagram of a location-based access control system 1 according to an embodiment of the invention;

FIG. 2 is a block diagram of a cloud server 2 according to an embodiment of the invention;

FIG. 3 is a block diagram of a client terminal 3 according to an embodiment of the invention;

FIG. 4 is a flowchart of a location-based access control method 4 according to an embodiment of the invention; and

FIG. 5 is a flowchart of a location-based access control method 5 according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Various aspects described herein are in connection with an access control system which provides security for everyday processes and applications such as access control, login control, payment security, unlock/lock operation, register check, and alarm activation/deactivation. The access control system incorporates client terminals and cloud servers. The client terminal may also be referred to as a point-of-sale (POS) device, wireless communication device, a second client terminal, a mobile station, a system, a device, a wireless terminal, a subscriber unit, a subscriber station, a mobile, a remote station, a remote terminal, an access terminal, a user terminal, a terminal, a communication device, a wireless device, a portable communication device, a user agent, a user device, or user equipment (UE). In particular, the POS device may be a scanner, an electronic and manual cash register, an EFTPOS terminal, a touch screens and a variety of other hardware and software available at a retailer store. The mobile station may be a cellular telephone, a smartphone, a pager, a media player, a gaming console, a Session Initiation Protocol (SIP) phone, Personal Digital Assistant (PDA), a tablet computer, a laptop computer, a handheld device having wireless connection capability, a computing device, or any processing device connected to a wireless modem.

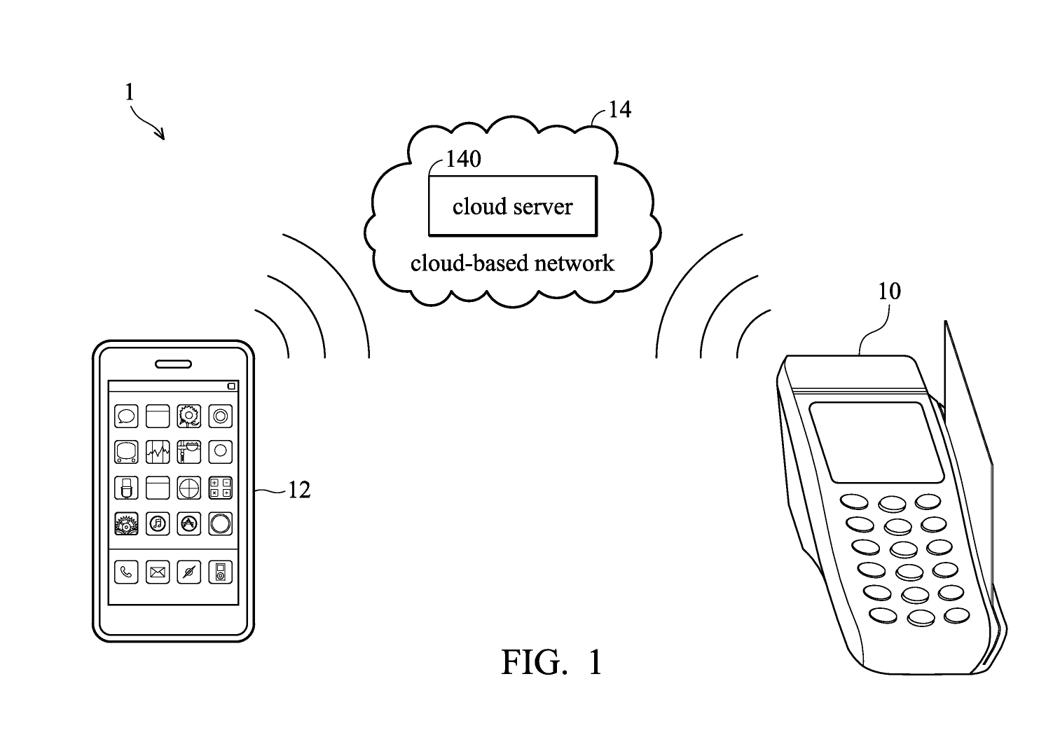

FIG. 1 is a block diagram of a location-based access control system 1 according to an embodiment of the invention, including a point-of-sale (POS) device 10, a smartphone 12, and a cloud-based network 14. The smartphone 12 may be connected to the cloud-based network 14 via a wireless connection. The POS device 10 may be connected to the cloud-based network 14 via a wired connection (not shown) or a wireless connection.

The location-based access control system 1 provides secure payment environment to perform a location-based authentication process for making a credit card payment. Since a smartphone user is often heavily dependent on his/her smartphone and keeps his/her smartphone in a close distance most of the time, the location of the smartphone 12 often indicates the location of its owner. The location-based access control system 1 compares the locations of the location of the POS device 10 and the smartphone 12 to determine whether the owner of the smartphone 12 is making a payment at the POS device 10. When the locations of the POS device 10 and the smartphone 12 are matched, it would indicate that the owner of the smartphone 12 is at the location of the POS device 10 making the credit card payment, and authentication information sent from the POS device 10 is not breached data of the credit card and the credit card authentication process should proceed. Conversely, when the locations of the POS device 10 and the smartphone 12 are mismatched, it would indicate that the owner of the smartphone 12 is not at the location of the POS device 10 making the credit card payment, and the authentication information sent from the POS device 10 may be breached data of the credit card and the credit card authentication process should be terminated.

Specifically, when the credit card payment is made at the POS device 10, the location-based access control system 1 may compare a radio environment of the POS device 10 to that of the smartphone 12, and initiate an authentication of the credit card at the POS device 10 only when the radio environments of the POS device 10 and the smartphone 12 match with each other. The radio environments of the POS device 10 and the smartphone 12 represent locations of the POS device 10 and the smartphone 12, and may contain device identifiers, addresses, and signal strengths of detected signal sources. The radio environment may contain one or more detected radio sources. For example, when the detected signal source is a WiFi AP, the radio environment may include an identifier, a media access control (MAC) address, and a received signal strength indicator (RSSI) (signal strength) of the WiFi AP. When the detected signal source is a Bluetooth device, the radio environment may include a Bluetooth identifier, a Bluetooth address, and a Bluetooth RSSI (signal strength) of the Bluetooth device. When the detected signal source is an AP of a small cell such as a picocell or a femtocell, the radio environment may include a cell identifier and a RSSI (signal strength) of the small cell. When the detected signal source is a base station, the radio environment may include a cell identifier and a RSSI (signal strength) of the base station.

The cloud-based network 14 contains a cloud server 140 for authenticating credit cards. Upon the POS device 10 receives a credit card operation, e.g. a card swipe, it may scan radio sources in the environment to generate a first radio environment and transmit an access control request and the first radio environment to the cloud-based network 14 to initiate the location-based authentication process.

In some implementations, the POS device 10 transmits the access control request and the first radio environment to the cloud server 140 in the cloud-based network 14 to initiate the location-based authentication process. The POS device 10 may send the access control request and the first radio environment to the cloud server 140 in separate messages or in a common message. The access control request may contain authentication information of the credit card. Upon receiving the access control request, the cloud server 140 may send a request message to the smartphone 12 to request for scanning the radio environment of the smartphone 12. In response, the smartphone 12 may scan radio sources in the environment to generate a second radio environment and transmit the second radio environment back to the cloud server 140. Then the cloud server 140 may compare the second radio environment from the smartphone 12 to the first radio environment from the POS device 10. When the first and second radio environments are mismatched, the cloud server 140 may terminate the location-based authentication process. When the first and second radio environments are matched, the cloud server 140 may proceed the location-based authentication process by validating the authentication information of the credit card. The cloud server 140 may authorize or grant the credit card payment when the authentication information of the credit card is valid, and decline the credit card payment when the authentication information of the credit card is invalid.

In other implementations, the POS device 10 also transmits the access control request and the first radio environment to the cloud server 140 in the cloud-based network 14 to initiate the location-based authentication process. The POS device 10 may send the access control request and the first radio environment to the cloud server 140 in separate messages or in a common message. The access control request may contain authentication information of the credit card. In response, the cloud server 140 may send a secondary access control request and the first radio environment to the smartphone 12. The secondary access control request is a request for the smartphone 12 to compare its current radio environment with the first radio environment. As a result, once the smartphone 12 receives the secondary access control request and the first radio environment, it may scan its surrounding radio environment to generate a second radio environment, and compare the second radio environment of the smartphone 12 to the first radio environment of the POS device 10. When the first and second radio environments are mismatched, the smartphone 12 may transmit an access control decline to the cloud server 140 to terminate the location-based authentication process. When the first and second radio environments are matched, the cloud server 140 may transmit an access control grant to the cloud server 140 to proceed the location-based authentication process. When the access control decline is received, the cloud server 140 may stop the credit card payment. When the access control grant is received, the cloud server 140 may proceed to validate the authentication information of the credit card. The cloud server 140 may authorize or grant the credit card payment when the authentication information of the credit card is valid, and decline the credit card payment when the authentication information of the credit card is invalid. In this implementation, the access control is performed in the smartphone 12, the cloud server 140 does not the location of the smartphone 12, thus the privacy of the user of the smartphone is preserved.

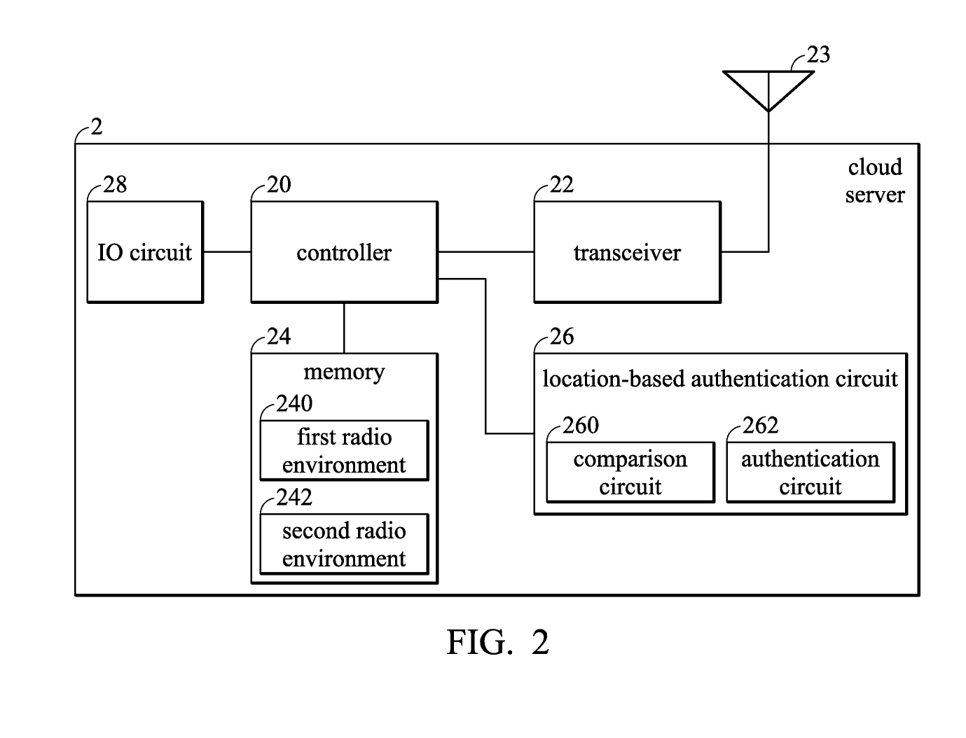

FIG. 2 is a block diagram of a cloud server 2 according to an embodiment of the invention, including a controller 20, a transceiver 22, a memory device 24, a location-based authentication circuit 26, and an input/output (IO) circuit 28. The cloud serve 2 may serve as the cloud serve 140 in FIG. 1, receiving an access control request from a first client terminal such as a POS device to initiate a location-based authentication process.

The controller 20 controls operations of the transceiver 22, the memory device 24, the location-based authentication circuit 26, and the IO circuit 28. The IO circuit 28 may establish a wired connection to a wired client terminal such as a POS device. The transceiver 22 and the antenna 23 may establish a wireless connection to a wireless client terminal such as a smartphone. The TO circuit 28 and/or the transceiver 22 may receive an access control request and a first radio environment 240 from a first client terminal (not shown), and receive a second radio environment 242 from a second client terminal (not shown), and store the first radio environment 240 and the second radio environment 242 onto the memory device 24.

The first client terminal may be an access control device with restricted use such as access control, login control, payment security, unlock/lock operation, register check, and alarm activation/deactivation. The second client terminal may be a carry-on device used to identify the current location of a user. The access control request and the first radio environment 240 may be received through separate messages or a common message from the first client terminal. The access control request contains authentication information such as a credit card number, an expiration date, a billing address, an amount of a payment, a user name, a user password, a login time, and other security control data. The first radio environments include a first list of device identities, addresses, and signal strengths of Radio Frequency (RF) signal sources, and the second radio environment comprise a second list of device identities, addresses, and signal strengths of RF signal sources scanned by the second client terminal.

After receiving the second radio environment 242, the location-based authentication circuit 26 may process the access control request based on the first radio environment 240 and the second radio environment 242. The location-based authentication circuit 26 contains a comparison circuit 260 and an authentication circuit 262. Upon receiving the access control request, the comparison circuit 260 may send an environment scan request through the transceiver 22 and the antenna 23 to the second client terminal, requesting the second client terminal to scan its current radio environment as the second radio environment 242. The comparison circuit 260 may compare the second radio environment 242 to the first radio environment 240. When the first radio environment 240 matches with the second radio environment 242, it implies that the user of the first client terminal is near the second client terminal, and the access control request is likely to be true, thus the authentication circuit 262 may proceed the access control request. Whereas when the first radio environment 240 does not matches with the second radio environment 242, it implies that the user of the first client terminal is not near the second client terminal, and the access control request is likely to be false, thus the comparison circuit 260 may decline the access control request.

The comparison circuit 260 may determine that the first radio environment 240 matches with the second radio environment 242 by similarities between the first radio environment 240 and the second radio environment 242, which are determined by combinations and/or sequences of the listed RF signal sources in the first radio environment 240 and the second radio environment 242. In one embodiment, the comparison circuit 260 may compare the combinations of the listed RF signal sources in the first radio environment 240 and the second radio environment 242 to determine whether the first radio environment 240 matches to the second radio environment 242. In another embodiment, the comparison circuit 260 may compare the sequences of the listed RF signal sources in the first radio environment 240 and the second radio environment 242 to determine whether the first radio environment 240 matches to the second radio environment 242. Examples of the two embodiments are illustrated by the first list of the first radio environment from a first client device and the second list of the second radio environment from a second client device in Table 1 below:

TABLE 1

| First list | Second list |
|---|---|
| WiFi_AP_0; mac = | WiFi_AP_0; mac = |
| aa:bb:cc:dd:ee:f0; RSSI = −70 | aa:bb:cc:dd:ee:f0; RSSI = −65 |
| WiFi_AP_1; mac = | WiFi_AP_1; mac = |
| aa:bb:cc:dd:ee:f1; RSSI = −80 | aa:bb:cc:dd:ee:f1; RSSI = −74 |
| WiFi_AP_2; mac = | WiFi_AP_2; mac = |
| aa:bb:cc:dd:ee:f2; RSSI = −90 | aa:bb:cc:dd:ee:f2; RSSI = −85 |
| WiFi_AP_3; mac = | WiFi_AP_3; mac = |
| aa:bb:cc:dd:ee:f3; RSSI = −80 | aa:bb:cc:dd:ee:f3; RSSI = −75 |
| BT_device_0; BT_addr = | BT_device_0; BT_addr = |
| xxxxxx:yy:zzzz; RSSI = −70 | xxxxxx:yy:zzzz; RSSI = −65 |

The first list contains 4 WiFi signal sources and 1 Bluetooth signal source; and the second list also contains 4 WiFi signal sources and 1 Bluetooth signal source. Each signal source contains information of the device identifier, the device address, and the received signal strength. For example, WiFi information “WiFi_AP_0; mac=aa:bb:cc:dd:ee:f0; RSSI=−70” indicates that a WiFi AP has a device ID of WiFi_AP_0, an MAC address of aa:bb:cc:dd:ee:f0, and a received signal strength indicator of −70 dB. The comparison circuit 260 may determine that the first list matches with the second list by the combinations of the RF radio sources. Specifically, when the device IDs of the RF radio sources in the first list are substantially the same to those in the second list, the comparison circuit 260 may determine that the first list matches with the second list. For example, the first and second lists in Table 1 both contain WiFi_AP_0, WiFi_AP_1, WiFi_AP_2, WiFi_AP_3, and BT_device_0, thus the comparison circuit 260 determines that the first list matches with the second list. The comparison circuit 260 may also determine that the first list matches with the second list by the sequences of the signal strengths belonging to the same radio source type. In particular, when the sequence of the signal strengths in the first list with a certain radio source type is substantially the same to that in the second list, the comparison circuit 260 may determine that the first list matches with the second list. For example, the sequence of the signal strengths in the first list with the WiFi type is WiFi_AP_0, WiFi_AP_1, WiFi_AP_3, and WiFi_AP_2, and the sequence of the signal strengths in the first list with the WiFi type is also WiFi_AP_0, WiFi_AP_1, WiFi_AP_3, and WiFi_AP_2, consequently the first list matches with the second list.

The authentication circuit 262 may determine whether the authentication information in the access control is valid. When the authentication information is valid, e.g., the credit card number and the expiration date are valid, the authentication circuit 262 may grant the access control request, e.g., authorizing the credit card payment. When the authentication information is invalid, e.g., the credit card number and the expiration date are invalid, the authentication circuit 262 may decline the access control request, e.g., declining the credit card payment.

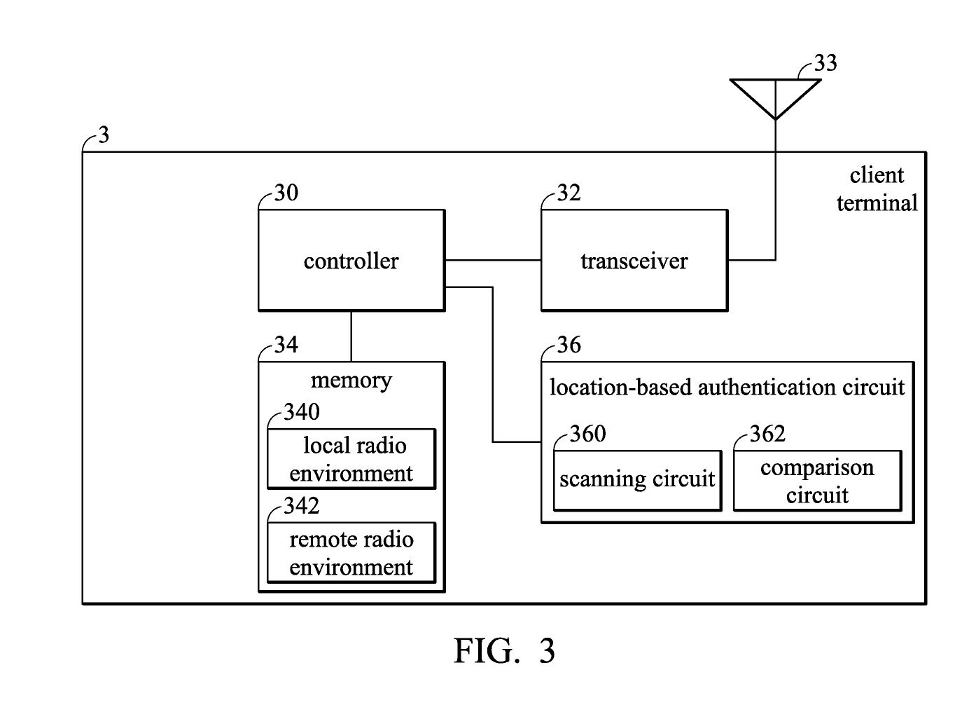

FIG. 3 is a block diagram of a client terminal 3 according to an embodiment of the invention, including a controller 30, a transceiver 32, a memory device 34, and a location-based authentication circuit 36. The client terminal 3 may serve as the smartphone 12 in FIG. 1, receiving an access control request from a cloud server to initiate a location-based authentication process.

The controller 30 controls operations of the transceiver 33, the memory device 34, and the location-based authentication circuit 36. The transceiver 32 and the antenna 33 may establish a wireless connection to a cloud server (not shown) in a cloud network, and receive the access control request and a remote radio environment 342 from the cloud server, and store the remote radio environment 342 onto the memory device 34. The remote radio environment 342 contains the radio environment of an access control device such as a POS machine.

The location-based authentication circuit 36 contains a scanning circuit 360 and a comparison circuit 362. Upon receiving the access control request, the scanning circuit 360 may scan the local radio environment to generate a local radio environment 340, which is subsequently stored in the memory device 34.

The comparison circuit 362 may compare the local radio environment 340 to the remote radio environment 342. When the remote radio environment 342 matches with the local radio environment 340, it implies that the user of the client terminal 3 is near the access control device, and the access control request is likely to be true, thus the comparison circuit 362 may transmit an access control grant to the cloud server to continue the access control process. Whereas when the remote radio environment 342 does not matches with the local radio environment 340, it implies that the user of the client terminal 3 is not near the access control device, and the access control request is likely to be false, thus the comparison circuit 362 may sent an access control decline to the cloud server to decline the access control process. In addition, the comparison circuit 362 may determine that local radio environment 340 matches with the remote radio environment 342 when the devices identities of the RF signal sources in the first and second lists match with each other and orders of the signal strengths of the RF signal sources in the first and second lists match with each other, examples are detailed as the embodiment in FIG. 2.

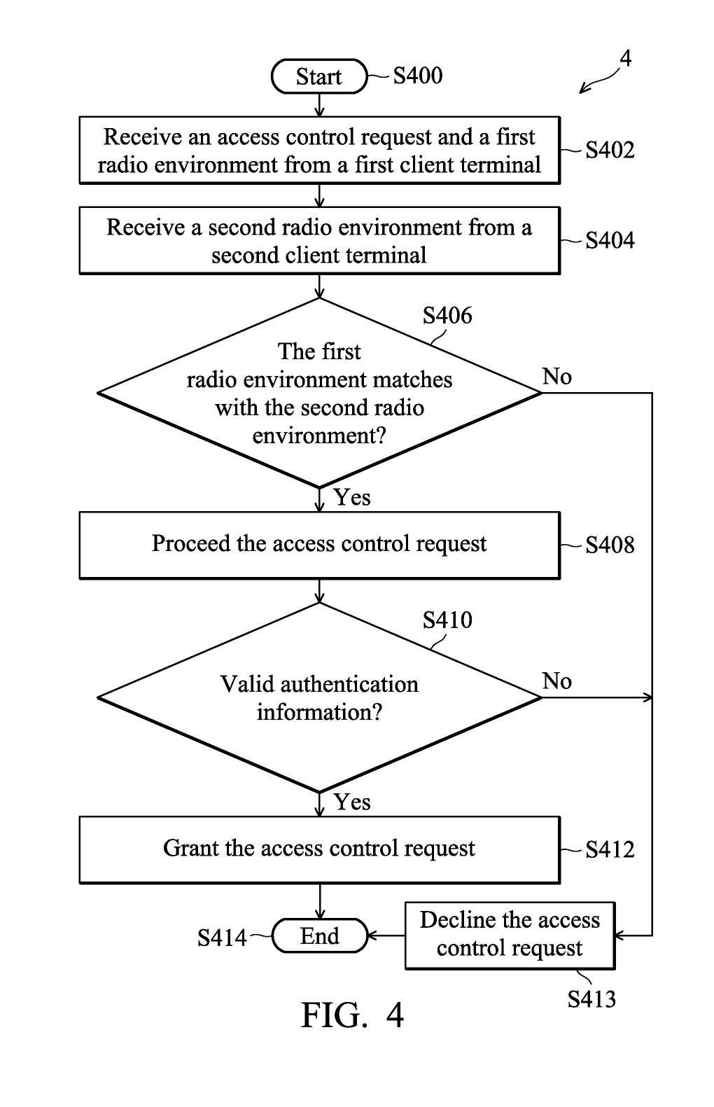

FIG. 4 is a flowchart of a location-based access control method 4 according to an embodiment of the invention, incorporating the cloud server 2 in FIG. 2. The location-based access control method 4 may be embodied as executable codes resident in a memory device and executed by a processor, or a hardware circuit which performs the operation.

The location-based access control method 4 is initiated upon power-up or when an access control procedure is activated (S400). After initiation, the location-based access control method 4 may receive an access control request and a first radio environment from a first client terminal (S402), receive an identity control request and a first radio environment from a first client terminal (S404), and compare the first and second radio environments to determine whether the first radio environment matches with the second radio environment (S406).

If so, the location-based access control method 4 may proceed the access control request (S408), otherwise, the location-based access control method 4 may decline the access control request (S411) and quit (S414).

When the location-based access control method 4 determines to proceed the access control request, it may next determine whether the authentication information in the access control request is valid (S410). If the authentication information in the access control request is valid, the location-based access control method 4 may grant the access control request from the first client terminal (S412) and exit (S414).

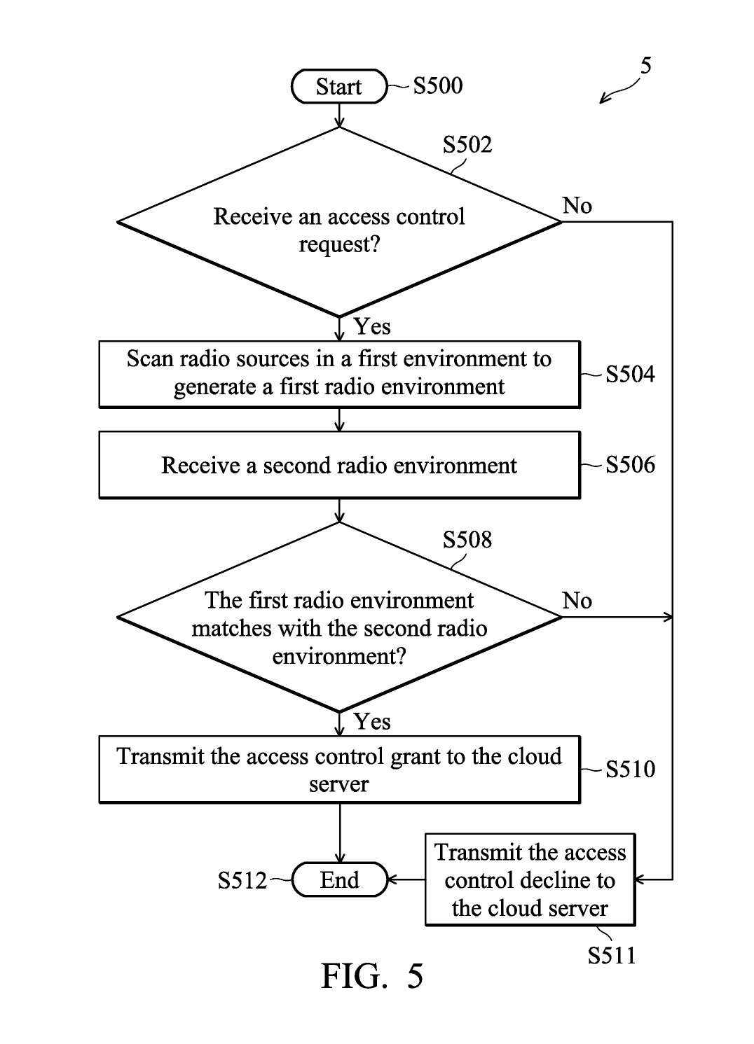

FIG. 5 is a flowchart of a location-based access control method 5 according to another embodiment of the invention, incorporating the client terminal 3 in FIG. 3. The location-based access control method 5 may be embodied as executable codes resident in a memory device and executed by a processor, or a hardware circuit which performs the operation.

The location-based access control method 5 is initiated upon power-up or when an access control procedure is activated (S500). After initialization, the location-based access control method 5 may determine whether an access control request is received from a cloud server (S502). If an access control request is received, the location-based access control method 5 may scan radio sources in a first environment to generate a first radio environment (S504) and receive a second radio environment from the cloud server (S506). If no access control request has been received, the location-based access control method 5 may exit (S512).

After acquiring the first and second radio environments, the location-based access control method 5 may determines whether the first radio environment matches with the second radio environment (S508). If so, an access control grant may be transmitted to the cloud server to continue the subsequent processes (S510), otherwise, an access control grant may be transmitted to the cloud server to terminate the subsequent processes (S511). The subsequent processes may be for example, validating the authentication information of a credit card payment.

After transmitting the response to the access control request, the location-based access control method 5 is completed and exited (S512).

The embodiments in FIGS. 1 through 5 provide the location-based access control methods, the access control system, the cloud server, and the terminal devices utilizing the same to allow the access of the sensitive information by location information such as the radio environments of the terminal devices, thereby providing increased information security and privacy.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application-specific integrated circuit (ASIC), a field programmable gate array signal (FPGA) or another programmable logic device, discrete gate or transistor logic, discrete hardware components or any combination thereof designed to perform the functions described herein. A general-purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method, adopted by a cloud server to provide access controls, comprising:
receiving an access control request and a first radio environment from a first client terminal;
receiving a second radio environment from a second client terminal; and
processing the access control request based on the first radio environment and the second radio environment.

2. The method of claim 1, wherein the step of processing the access control request comprises:
proceeding the access control request when the first radio environment matches with the second radio environment; and
declining the access control request when the first radio environment does not match with the second radio environment.

3. The method of claim 2 wherein the access control request comprises authentication information; and
the step of proceeding the access control request comprises: granting the access control request when the authentication information is valid.

4. The method of claim 1, wherein the first radio environment comprise a first list of device identities and signal strengths of Radio Frequency (RF) signal sources scanned by the first client terminal, and the second radio environment comprise a second list of device identities and signal strengths of RF signal sources scanned by the second client terminal.

5. The method of claim 1, wherein the step of processing the access control request comprises:
determining whether the first radio environment matches with the second radio environment by similarity between the first and second radio environments.

6. A method, adopted by a client terminal to provide access controls, comprising:
upon receiving an access control request from a cloud server, scanning radio sources in a first environment to generate a first radio environment;
receiving a second radio environment from the cloud server; and
processing the access control request based on the first radio environment and the second radio environment.

7. The method of claim 6, wherein the step of processing the access control request comprises:
transmitting an access control grant to the cloud server when the first radio environment and the second radio environment are matched; and
transmitting an access control decline to the cloud server when the first radio environment and the second radio environment are mismatched.

8. The method of claim 6, wherein the first radio environment comprise a first list of device identities and signal strengths of Radio Frequency (RF) signal sources scanned by the client terminal, and the second radio environment comprise a second list of device identities and signal strengths of RF signal sources scanned by the second client terminal.

9. The method of claim 6, wherein the step of processing the access control request comprises:
determining whether the first radio environment matches with the second radio environment by similarity between the first and second radio environments.

10. The method of claim 6, wherein the radio sources comprises an access point, a Bluetooth device, and a base station.

11. A cloud server, providing access controls, comprising:
a transceiver, configured to receive an access control request and a first radio environment from a first client terminal, and receive a second radio environment from a second client terminal; and
a location-based authentication circuit, coupled to the transceiver, configured to process the access control request based on the first radio environment and the second radio environment.

12. The cloud server of claim 11, wherein the location-based authentication circuit is further configured to:
proceed the access control request when the first radio environment matches with the second radio environment; and
decline the access control request when the first radio environment does not match with the second radio environment.

13. The cloud server of claim 12, wherein the access control request comprises authentication information; and
the location-based authentication circuit is further configured to grant the access control request when the authentication information is valid.

14. The cloud server of claim 11, wherein the first radio environment comprise a first list of device identities and signal strengths of Radio Frequency (RF) signal sources scanned by the first client terminal, and the second radio environment comprise a second list of device identities and signal strengths of RF signal sources scanned by the second client terminal.

15. The cloud server of claim 11, wherein the location-based authentication circuit is configured to determine whether the first radio environment matches with the second radio environment by similarity between the first and second radio environments.

16. A client terminal, providing access control, comprising:
a transceiver, upon receiving an access control request from a cloud server, configured to scan radio sources in a first environment to generate a first radio environment, and a second radio environment from the cloud server; and
a location-based authentication circuit, coupled to the transceiver, configured to process the access control request based on the first radio environment and the second radio environment.

17. The client terminal of claim 16, wherein the location-based authentication circuit is further configured to:
transmit an access control grant to the cloud server when the first radio environment matches with the second radio environment; and
transmit an access control decline to the cloud server when the first radio environment does not match with the second radio environment.

18. The client terminal of claim 16, wherein the first radio environment comprise a first list of device identities and signal strengths of Radio Frequency (RF) signal sources scanned by the client terminal, and the second radio environment comprise a second list of device identities and signal strengths of RF signal sources scanned by the second client terminal.

19. The client terminal of claim 18, wherein the location-based authentication circuit is configured to determine whether the first radio environment matches with the second radio environment by similarity between the first and second radio environments.

20. The client terminal of claim 16, wherein the radio sources comprises an access point, a Bluetooth device, and a base station.
